(19) United States
(12) Patent Application Publication
(10) Pub. No.: US 2014/0370155 A1
(43) Pub. Date: Dec. 18, 2014

(54) STABILIZED CONCENTRATED LIQUID HUMAN MILK FORTIFIER

(71) Applicant: ABBOTT LABORATORIES, ABBOTT PARK, IL (US)

(72) Inventors: Mustafa Vurma, Dublin, OH (US); Gul Konuklar, New Albany, OH (US)

(73) Assignee: ABBOTT LABORATORIES, ABBOTT PARK, IL (US)

(21) Appl. No.: 14/362,534

(22) PCT Filed: Dec. 3, 2012
(86) PCT No.: PCT/US2012/067589

§ 371 Date: Jun. 3, 2014

Related U.S. Application Data
(60) Provisional application No. 61/581,634, filed on Dec. 30, 2011.

(51) Int. Cl. A23C 9/20; A23C 9/152

(52) U.S. Cl. CPC A23C 9/206; A23C 9/1526; A23C 9/152
USPC 426/72; 426/590; 426/580

(57) ABSTRACT

Disclosed are shelf-stable concentrated liquid human milk fortifiers including extensively hydrolyzed casein. The long term shelf stable, concentrated liquid human milk fortifiers include octenyl succinic acid (OSA) modified waxy potato starch as a stabilizer.

### CROSS REFERENCE TO RELATED APPLICATIONS

The present application hereby claims the benefit of the provisional patent application Ser. No. 61/581,634, filed Dec. 30, 2011, the disclosure of which is hereby incorporated by reference in its entirety.

### FIELD OF THE DISCLOSURE

The present disclosure relates to a stable, concentrated liquid human milk fortifier including an improved stabilizer. More particularly, the present disclosure relates to a long term stable, concentrated liquid human milk fortifier including octenyl succinic acid (OSA) modified waxy potato starch as a stabilizer. In some embodiments, the concentrated liquid human milk fortifier additionally includes extensively hydrolyzed casein as at least part of the protein component.

### BACKGROUND OF THE DISCLOSURE

Human milk is generally recognized as an ideal feeding for most infants due to its overall nutritional composition. It is well known and generally accepted that human milk provides infants with unique immunologic and developmental benefits as compared generally to commercially available infant formulas.

For some infants, however, especially preterm infants, human milk does not always meet the complete nutritional needs. Although these infants still generally benefit from human milk, it is often desirable to supplement their human milk feedings with additional nutrients in the form of a human milk fortifier. Initially, these preterm infants may grow more rapidly than many of their term counterparts, and accelerated growth often requires additional nutrition, which is made possible by the use of a human milk fortifier in combination with human milk. As such, the use of human milk fortifiers in neonatal intensive care units has grown substantially and become a standard of practice.

Most of the human milk fortifiers described in the literature and commercially available have been formulated as reconstitutable powders rather than liquids in order to minimize the volume displacement of human milk by the fortifier. The minimization of volume displacement by the fortifier is important as the infant can only intake a certain amount of fluid per feeding. The reconstitutable human milk fortifier powders may, however, carry the inherent risk of microbial contamination in some cases.

Although liquid human milk fortifiers have been considered as potential replacements for the reconstitutable powders, liquid human milk fortifiers generally displace more volume than powders and have additionally been confronted with at least two additional problems that can potentially shorten shelf life and commercial acceptance. The first problem is known as creaming, whereby the fat globules in the liquid nutritional composition float to the top of the product. If these fat globules are allowed to harden, a seal is effectively formed across the top of the liquid nutritional composition's container. Additionally, these hard, fatty deposits can block or clog feeding tubes or nipples, and can give the liquid nutritional composition an unappealing appearance and cause nutritional insufficiencies.

The second problem associated with many liquid human milk fortifiers is sedimentation, whereby nutrients, such as minerals, come out of solution and settle to the bottom of the liquid nutritional composition's container. The problem of sedimentation is made more acute where the sediment hardens into a cementous type of material known as “nondispersible sediment”. The problem with nondispersible sediment is two-fold. First, the liquid human milk fortifier may now be subject to nutrient deficiency as the nondispersible sediment is often difficult to re-solubilize into solution upon agitation. The second problem with nondispersible sediment is that it, similar to hardened creaming deposits, can plug feeding tubes or nipples.

Additionally, due to sensitive digestive systems and poor tolerance in many preterm infants, it is generally advantageous to utilize hydrolyzed proteins, and desirably extensively hydrolyzed proteins, in human milk fortifiers. However, as compared to intact proteins, or lightly hydrolyzed proteins, extensively hydrolyzed proteins (i.e., proteins having a degree of hydrolysis of about 20% or more) tend to have poor ability to form long term stable emulsions, further complicating their use in liquid human milk fortifiers. Additionally, the presence of high levels of insoluble minerals such as calcium salts may also cause a number of stability issues when used in combination with extensively hydrolyzed proteins. As such, manufacturing long term stable concentrated liquid human milk fortifiers including extensively hydrolyzed proteins has proven difficult.

In the field of liquid nutritional compositions, stabilizers are used to maintain the rheological properties of the liquids over their shelf lives while maintaining their organoleptic properties and appearance. Modified stabilizer systems have been proposed to address sedimentation problems; however, they have met with limited success. These systems permit the minerals to be suspended longer, but nevertheless, they ultimately irreversibly fall out of solution. Additionally, the stabilizers utilized to date have had limited success in stabilizing concentrated liquid nutritionals that include extensively hydrolyzed proteins.

As such, there is a need for highly concentrated long term stable liquid human milk fortifiers including extensively hydrolyzed proteins. Additionally, it would be very beneficial if the highly concentrated human milk fortifier could be formulated to provide additional macro- and micro-nutrients without unwanted mineral fallout during storage.

### SUMMARY OF THE DISCLOSURE

The present disclosure is directed to long term stable, concentrated liquid human milk fortifiers including extensively hydrolyzed casein and octenyl succinic anhydride modified waxy potato starch. In some embodiments, the extensively hydrolyzed casein is the sole source of protein in the concentrated liquid human milk fortifier. The concentrated liquid human milk fortifiers may be, in some embodiments, hypoallergenic.

The disclosed liquid human milk fortifiers advantageously use a single stabilizer system to provide long term stable emulsions that have a very low level of sedimentation even in the presence of a high level of insoluble calcium salts, while allowing the use of an extensively hydrolyzed protein. The liquid human milk fortifier is emulsion stable without substantial mineral fallout and allows for homogeneous and precise delivery of micronutrients and other minor nutrients to the human milk or infant formula. Additionally, because the disclosed liquid human milk fortifier is a highly concentrated sterile liquid, the risk of microbial contamination is reduced and the volume displacement in human breast milk or infant formula is minimized.

An embodiment of the disclosed concentrated liquid human milk fortifier is preferably carrageenan-free, comprises from about 1% to about 50% by weight protein, on a dry weight basis, and octenyl succinic anhydride modified waxy potato starch and optionally further comprises fat, vitamins and minerals, wherein at least a portion of the protein is extensively hydrolyzed casein, preferably wherein the protein is extensively hydrolyzed casein at 100% by weight of the total protein component, more preferably wherein the extensively hydrolyzed casein at 100% by weight of the total protein component is hypoallergenic protein.

In another embodiment of the disclosed concentrated liquid human milk fortifier, the fortifier further comprises the octenyl succinic anhydride modified waxy potato starch, which is present in the concentrated liquid human milk fortifier at from 0.1% to 3.5%, preferably from 0.8% to 1.5%, by weight of the fortifier. In another embodiment, the octenyl succinic anhydride modified waxy potato starch is a sole stabilizer of the concentrated liquid human milk fortifier.

In another embodiment of the disclosed concentrated liquid human milk fortifier, the fortifier further comprises a solids content of at least 5% by weight, preferably from 20% to 55% by weight.

In another embodiment of the disclosed concentrated liquid human milk fortifier, the fortifier is an aseptically-sterilized concentrated liquid human milk fortifier.

In another embodiment of the disclosed concentrated liquid human milk fortifier, the fortifier is carrageenan-free and comprises from 1% to 50% by weight of extensively hydrolyzed hypoallergenic casein, from 0.8% to 1.5% by weight, octenyl succinic anhydride modified waxy potato starch, and a solids content of from 20% to 55% by weight. In another embodiment, the octenyl succinic anhydride modified waxy potato starch is a sole stabilizer.

In another embodiment, the disclosure is directed to the use of a concentrated liquid human milk fortifier according to any one of the preceding embodiments.

An embodiment of the present disclosure is a method of fortifying breast milk comprising mixing a concentrated liquid human milk fortifier with breast milk in a volume to volume ratio of from 1:3 to 1:10, preferably from 1:3.5 to 1:7, the liquid human milk fortifier comprising from 1% to 50% by weight protein, on a dry weight basis, and octenyl succinic anhydride modified waxy potato starch, wherein at least a portion of the protein is extensively hydrolyzed casein, preferably wherein the protein is extensively hydrolyzed casein at 100% by weight of the total protein component, more preferably wherein the extensively hydrolyzed casein at 100% by weight of the total protein component is hypoallergenic protein.

In another embodiment of the method, the fortifier further comprises the octenyl succinic anhydride modified waxy potato starch, which is present in the concentrated liquid human milk fortifier at from 0.1% to 3.5%, preferably from 0.8% to 1.5%, by weight of the fortifier. In another embodiment, the octenyl succinic anhydride modified waxy potato starch is a sole stabilizer of the concentrated liquid human milk fortifier.

An embodiment of the present disclosure is a method of reducing creaming and sedimentation in a nutritional liquid, the method comprising preparing a nutritional liquid with octenyl succinic anhydride modified waxy potato starch, wherein the nutritional liquid comprises fat, carbohydrate, and protein, and wherein at least a portion of the protein is extensively hydrolyzed casein.

It has been unexpectedly found that stable concentrated liquid human milk fortifiers and concentrated liquid nutritional compositions can advantageously be prepared with OSA modified waxy potato starch as a stabilizer, and in some embodiments, as the sole stabilizer. The use of OSA modified waxy potato starch provides for improved mineral suspension in combination with improved emulsion stability in the liquid human milk fortifier due to its unique physiochemical characteristics. Surprisingly, when the OSA modified waxy potato starch is introduced into the liquid human milk fortifier, the concentrated liquid can be prepared with high levels of insoluble calcium salts and extensively hydrolyzed protein without mineral fallout or separation.

Additionally, the concentrated liquid human milk fortifiers and liquid nutritional compositions can be prepared to include hypoallergenic extensively hydrolyzed casein proteins, which is beneficial for use in low birth weight and preterm infants having sensitive digestive systems. These liquids including extensively hydrolyzed casein proteins can be prepared without disrupting the long term stability or emulsion properties of the liquid. By preparing a concentrated liquid utilizing a OSA modified waxy potato starch as a stabilizer, the concentrated liquid may include up to 100% extensively hydrolyzed casein (by weight of the protein component) while maintaining the desired emulsion and stability properties.

### BRIEF DESCRIPTION OF THE DRAWINGS

FIG. 1 depicts a sample of concentrated liquid human milk fortifier including no stabilizer.

FIG. 2 depicts a sample of concentrated liquid human milk fortifier including OSA modified waxy corn starch as a stabilizer.

FIG. 3 depicts a sample of concentrated liquid human milk fortifier including OSA modified waxy potato starch as a stabilizer.

FIGS. 4A-4C depicts samples of concentrated liquid human milk fortifiers including various stabilizers as analyzed in Example 5.

FIG. 5 is a graph depicting elasticity behavior of various concentrated liquid human milk fortifiers as a function of strain as analyzed in Example 6.

FIG. 6 is a graph depicting dynamic modula of various concentrated liquid human milk fortifiers as a function of frequency and temperature as analyzed in Example 7.

### DETAILED DESCRIPTION OF THE DISCLOSURE

The concentrated liquid human milk fortifiers of the present disclosure generally have a high solids content and extensively hydrolyzed casein in combination with OSA modified waxy potato starch. The liquid human milk fortifiers of the present disclosure address and provide a solution to the longstanding problem of providing a sterile, long term stable, hypoallergenic liquid human milk fortifier that can be used in combination with human breast milk or infant formula without significant volume displacement. The liquid human milk fortifiers of the present disclosure not only provide the significant benefit of improved sterility as compared to powdered human milk fortifiers that may potentially be subject to microbial contamination, but also provide a stable human milk fortifier that includes an extensively hydrolyzed protein that can be more easily digested and absorbed into the gut of an infant, and particularly a preterm infant, as compared to intact proteins. The previous problems of providing a long term stable liquid human milk fortifier with extensively hydrolyzed proteins has been overcome by including an OSA modified waxy potato starch in the human milk fortifiers disclosed herein. Even though extensively hydrolyzed proteins are well-known to have poor ability to form and stabilize emulsions and are highly prone to unwanted separation and sedimentation, the OSA modified waxy potato starch, in combination with extensively hydrolyzed protein, provides a long term stable emulsion with excellent sedimentation properties.

The use of OSA modified waxy potato starch provides for improved mineral suspension in combination with improved emulsion stability in the liquid human milk fortifier due to its unique physiochemical characteristics. Surprisingly, when the OSA modified waxy potato starch is introduced into the liquid human milk fortifier, the concentrated liquid can be prepared with high levels of insoluble calcium salts and extensively hydrolyzed protein without mineral fallout or separation.

By providing a long term stable concentrated liquid human milk fortifier that can be based partly or solely on an extensively hydrolyzed protein component, the present disclosure now provides a sterile, concentrated liquid product that can be used in neonatal intensive care units in combination with human breast milk or infant formula for preterm and term infants to provide the infant with the additional nutrients, including both protein and minerals, required for growth and maturation. This can now be done with a highly sterile, stable product that is highly concentrated so as to be more like a powdered human milk fortifier from a volume displacement perspective.

Additionally, the use of the OSA modified waxy potato starch as a single functional ingredient that provides for both emulsification and stabilization allows for the use of a label friendly starch in many commercial markets around the world to provide enhanced physical stability in a concentrated liquid human milk fortifier. This is a significant advancement as many gum-type stabilizers, including carrageenan, are not favored in many countries around the world and alternatives should be used.

These and other optional elements or limitations of the concentrated liquids and methods of the present disclosure are described in detail hereinafter.

The terms “retort packaging” and “retort sterilizing” are used interchangeably herein, and unless otherwise specified, refer to the common practice of filling a container, most typically a metal can or other similar package, with a nutritional liquid and then subjecting the liquid-filled package to the necessary heat sterilization step, to form a sterilized, retort packaged, nutritional liquid product.

The term “aseptic packaging” as used herein, unless otherwise specified, refers to the manufacture of a packaged product without reliance upon the above-described retort packaging step, wherein the nutritional liquid and package are sterilized separately prior to filling, and then are combined under sterilized or aseptic processing conditions to form a sterilized, aseptically packaged, nutritional liquid product.

The term “infant” as used herein, refers generally to individuals less than about 1 year of age, actual or corrected.

The term “preterm” are used herein refers to those infants born at less than 37 weeks gestation, having a birth weight of less than 2500 gm, or both.

The terms “fortifier solids” or “total solids”, unless otherwise specified, are used interchangeably herein and refer to all material components of the compositions of the present disclosure, less water.

The term “hypoallergenic” as used herein means that the concentrated liquid has a decreased tendency to provoke an allergic reaction in a user, such as a preterm or term infant, as compared to non-hypoallergenic liquids. More particularly, the concentrated liquid is hypoallergenic when there is 95% confidence that 90% of allergic infants would not react to the liquid in a double-blind, placebo-controlled study (DBPC). An example of a suitable DBPC study is described in Kleinman, et al. “Use of infant formulas in infants with cow milk allergy: a review and recommendations,” Pediatr Allergy Immunol 1991, 4: 146-155.

The term “extensively hydrolyzed” as used herein refers to protein that has been enzymatically or acidically hydrolyzed to have a degree of hydrolysis of at least 20%. Typically extensively hydrolyzed proteins exist primarily as di- and tripeptides.

The terms “liquid nutritional composition” and “nutritional liquid” are used interchangeably herein, and unless otherwise specified, refer to nutritional products, including human milk fortifiers, in concentrated form.

The terms “stable” and “shelf stable” as used herein mean that the concentrated liquid is resistant to separation of the liquid into two or more discernable layers (e.g., a top cream layer and a bottom serum layer) and precipitation/sediment formation on the bottom of a container for a time period after manufacture of at least three months desirably at least six months, desirably at least twelve months and more desirably at least 18 months.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the concentrated liquids of the present disclosure may also be substantially free of any optional or selected ingredient or feature described herein, provided that the remaining concentrated liquid still contains all of the required ingredients or features as described herein. In this context, and unless otherwise specified, the term “substantially free” means that the selected concentrated liquid contains less than a functional amount of the optional ingredient, typically less than 0.1% by weight, and also including zero percent by weight of such optional or selected ingredient.

The concentrated liquids and corresponding manufacturing methods of the present disclosure can comprise, consist of, or consist essentially of the elements and limitations of the disclosure as described herein, as well as any additional or optional ingredients, components, or limitations described herein or otherwise useful in the concentrated liquid.

### Product Form

While discussed primarily as a concentrated liquid human milk fortifier, it should be recognized by one skilled in the art that the concentrated compositions described herein may additionally include other concentrated liquid nutritional compositions that may be suspensions, emulsions or clear or substantially clear liquids. The resulting concentrated liquid nutritional compositions may be used as infant, pediatric, toddler, and/or adult liquid nutritional compositions and/or medicinal liquid nutritional compositions.

The concentrated liquid human milk fortifiers of the present disclosure have a solids content of at least 10%, or even at least 20%, including from about 20% to about 55%, and including from about 20% to about 50%, and including from about 20% to about 45%, and including from about 20% to about 40%, and including from about 25% to about 40%, and including from about 29% to about 32% by weight. The concentrated liquid human milk fortifiers are liquids that are capable of being poured directly from a package containing them into human milk or infant formula.

The concentrated liquid human milk fortifiers are generally formulated to have a caloric density of at least 1.25 kcal/ml (37 kcal/fl oz), including from about 1.4 kcal/ml (42 kcal/fl oz) to about 5 kcal/ml (149 kcal/fl oz), and also including from about 1.5 kcal/ml (44 kcal/fl oz) to about 2.5 kcal/ml (74 kcal/fl oz), and also including from about 1.9 kcal/ml (56 kcal/fl oz) to about 2.0 kcal/ml (59 kcal/fl oz).

The concentrated liquid human milk fortifiers include packaged compositions further comprising a suitable unit dose package or container. The term “unit dose” as used herein refers to individual, single-use, packages of concentrated liquid human milk fortifier containing an amount of human milk fortifier that can be used in a preparation of an infant feeding to provide sufficient human milk fortifier to supplement human milk for immediate use, e.g., preferably within 8-24 hours, more preferably within 0-4 hours, of mixing with human milk.

The amount of fortified human milk prepared for a premature infant, for example, typically ranges from 25 ml to 150 ml a day. Consequently, a single unit dose is the appropriate amount of fortifier solids to fortify a 25 ml preparation. Multiple packages can be used to prepare larger feeding volumes, especially for term infants.

The amount or volume of concentrated liquid human milk fortifier in each unit dose package includes those embodiments in which the package contains an amount suitable to prepare an infant's next feeding. These unit dose packages typically contain sufficient fortifier to provide from about 0.5 g to about 10 g of fortifier solids, more typically from about 0.8 g to about 7.5 g of fortifier solids, and even more typically from about 0.85 g to about 6.0 g, of fortifier solids.

The concentrated liquid human milk fortifiers of the present disclosure are preferably formulated so as to provide fortified human milk having an osmolality of less than 500 mOsm/kg water, preferably from about 300 mOsm/kg water to about 400 mOsm/kg water. Based on the disclosure herein, one skilled in the art can readily formulate the concentrated liquid human milk fortifier with the appropriate carbohydrate sources and corresponding DE (dextrose equivalence) values to obtain or otherwise provide for the targeted osmolality of the human milk fortifier when combined with human milk.

The concentrated liquid human milk fortifiers may suitably have a pH ranging from about 3.5 to about 8.0, but are most advantageously in a pH range of from about 4.5 to about 7.5, including from about 4.5 to about 7.0, including from about 4.5 to about 6.7, including from about 4.5 to about 6.5, and including from about 4.5 to about 6.0. In some embodiments, the pH range is from about 5.5 to about 7.3, including from about 5.5 to about 7.0, including from about 5.5 to about 6.5, and further including from about 5.5 to about 6.0. In other embodiments, the pH range is from about 6.2 to about 7.2, including from about 6.2 to about 7.0, and including from about 6.2 to about 6.5.

### Extensively Hydrolyzed Casein Protein

The concentrated liquid human milk fortifiers of the present disclosure include hypoallergenic extensively hydrolyzed casein as a protein source. Generally, the concentrated liquid human milk fortifiers will include at least 35%, including at least 50%, including at least 60%, including at least 75%, including at least 90%, and further including about 100% extensively hydrolyzed casein, by total weight of protein in the concentrated liquid human milk fortifier. In one desirable embodiment of the present disclosure, the concentrated liquid human milk fortifier includes 100% extensively hydrolyzed casein, by total weight of the protein in the concentrated liquid human milk fortifier. In this desirable embodiment, the concentrated liquid human milk fortifier is hypoallergenic. In some embodiments, the concentrated liquid human milk fortifier will include from about 35% to 100%, including from about 50% to 100%, further including from about 75% to 100% extensively hydrolyzed casein, by total weight of protein in the concentrated liquid human milk fortifier. As discussed further below, in some embodiments of the present disclosure, the concentrated liquid human milk fortifiers of the present disclosure may optionally include other hypoallergenic or non-hypoallergenic proteins in addition to the extensively hydrolyzed casein protein.

Extensively hydrolyzed casein proteins suitable for use in the concentrated liquid human milk fortifiers of the present disclosure include those having a degree of hydrolysis of from about 5% to about 80%, including from about 20% to about 60%, and further including from about 40% to about 60%. Generally, the extensively hydrolyzed casein has a ratio of total amino nitrogen (AN) to total nitrogen (TN) of from about 0.2 AN to 1.0 TN to about 0.4 AN to about 0.8 TN. Suitable commercially available extensively hydrolyzed caseins will generally have a protein level in the ingredient of from about 50% to about 95%, including from about 70% to about 90%. One suitable commercially available extensively hydrolyzed casein is Dellac. CE90, which is a spray dried powder casein hydrolysate (Friesland Campina Domo, Amersfoort, the Netherlands).

### Stabilizer System

The concentrated liquid human milk fortifiers of the present disclosure include an octenyl succinic anhydride (OSA) modified waxy starch as a stabilizer, and in some embodiments, as the sole stabilizer present in the human milk fortifier. As used herein, the term “waxy” is generally used to refer to starches to starches that have a high level of amylopectin and a low level of amylose. In some embodiments, the amylopectin content of the “waxy” starch will be more than 90% by weight, including more than 95% by weight, including more than 99% by weight. In some embodiments, the waxy potato starches described in the present disclosure will only contain amylopectin and no amylose.

The OSA modified starch, including the desirable OSA modified waxy potato starch, is generally prepared by esterifying a dextrinized, ungelatinized waxy potato starch with anhydrous octenyl succinic acid under alkaline conditions. Methods of this type are well known in the art. One suitable commercially available OSA modified waxy potato starch is ELIANE™ MC 160 (AVEBE, The Netherlands).

Suitable OSA modified waxy potato starches for use in the liquid human milk fortifiers have an average granule size of from about 15 μm to about 100 μm, desirably from about 20 μm to about 100 μm, desirably from about 30 μm to about 100 μm, which is generally larger than other modified starches, such as modified corn starch. The use of large granule-sized OSA modified waxy potato starches may potentially create strong, cohesive, and elastic networks improving the stabilization of concentrated liquids.

Further, suitable OSA modified waxy potato starches will have a phosphorous content, present as phosphate monoesters, of from about 800 ppm to about 1000 ppm, which is generally higher than other starches commercially available. For example, many corn starches have a phosphorous content of about 30 ppm, which is significantly below the desirable phosphorus content of the suitable OSA modified waxy potato starches. The phosphate monoesters have negatively charged molecules, which may increase the charge repulsion at the oil and water interface in the concentrated liquid human milk fortifier, preventing the oil droplets from coalescing and aggregating. Further, the increased charge repulsion causes an increase in water binding capacity, swelling powder, and viscoelastic properties of the system. This may provide the concentrated liquid human milk fortifiers with an improved mineral suspension.

The OSA modified waxy starch, including the desirable OSA modified waxy potato starch as described herein, is present in the concentrated liquid human milk fortifier in an amount of from about 0.1% to about 3.5%, including from about 0.6% to about 2.0%, including from about 0.8% to about 1.5%, and further including about 1.2% by weight of the concentrated liquid human milk fortifier.

In some embodiments, the concentrated liquid human milk fortifier may include the OSA modified waxy potato starch in combination with one or more other stabilizers including, for example, carrageenan or other gum-based stabilizers such as xanthan gum. In another embodiment, the OSA modified waxy potato starch is the sole stabilizer. In this embodiment, the fortifier may be substantially free of carrageenan, or even completely free of carrageenan to allow a concentrated liquid human milk fortifier to be prepared that does not include any carrageenan.

### Macronutrients

The concentrated liquid human milk fortifiers and concentrated liquid nutritional compositions of the present disclosure may comprise carbohydrate, fat, and protein macronutrients of sufficient types and amounts that, when used in combination with human milk or other feeding formula, help meet the nutritional needs of the user, especially the premature infant. In some desirable embodiments, the liquid concentrated human milk fortifier will include a carbohydrate, protein, and fat. The concentration of these macronutrients in the various embodiments of the present disclosure includes the ranges described hereinafter.

Protein

The concentrated liquid human milk fortifiers of the present disclosure comprise a protein suitable for use in infants, especially preterm infants, at concentrations ranging from about 1% to about 50%, including from about 20% to about 40%, also including from about 5% to about 30%, including from about 10% to about 25%, and including from about 15% to about 25%, on a dry weight basis. In some desirable embodiments, the protein concentration may be from about 7 to about 15 grams, including from about 9 to about 12 grams of protein per 100 grams of final liquid product.

As noted above, the protein component of the concentrated liquid human milk fortifiers of the present disclosure is at least partially comprised of extensively hydrolyzed casein. In a particularly desirable embodiment of the present disclosure, the protein component of the concentrated liquid human milk fortifier is entirely comprised of extensively hydrolyzed casein. In embodiments wherein additional proteins sources (i.e., one or more protein sources in addition to the extensively hydrolyzed protein source) are to be used in the concentrated liquid human milk fortifier in addition to the extensively hydrolyzed casein (i.e., the concentrated liquid human milk fortifier protein component is not 100% extensively hydrolyzed casein), the fortifier may still be made hypoallergenic by including additional hypoallergenic proteins such as soy protein hydrolysate, whey protein hydrolysate, rice protein hydrolysate, potato protein hydrolysate, fish protein hydrolysate, egg albumen hydrolysate, gelatin protein hydrolysate, pea protein hydrolysate, bean protein hydrolysate, combinations of animal and vegetable protein hydrolysates, and combinations thereof.

In this context, the terms “protein hydrolysates” or “hydrolyzed protein” are used interchangeably herein and include extensively hydrolyzed proteins, wherein the degree of hydrolysis is most often at least 5%, including from about 10% to about 80%, and also including from about 30% to about 80%, even more preferably from about 40% to about 60%. The degree of hydrolysis is the extent to which peptide bonds are broken by a hydrolysis method. The degree of protein hydrolysis for purposes of characterizing the extensively hydrolyzed protein component of these embodiments is easily determined by one of ordinary skill in the formulation arts by quantifying the amino nitrogen to total nitrogen ratio (AN/TN) of the protein component of the selected formulation. The amino nitrogen component is quantified by USP titration methods for determining amino nitrogen content, while the total nitrogen component is determined by the Tecator Kjeldahl method, all of which are well known methods to one of ordinary skill in the analytical chemistry art.

In other embodiments of the present disclosure, the concentrated liquid human milk fortifier, in addition to the extensively hydrolyzed protein, may include an additional non-hypoallergenic protein source including for example, partially hydrolyzed or non-hydrolyzed (intact) protein, and can be derived from any known or otherwise suitable source such as milk (e.g., casein, whey, lactose-free milk protein isolates), animal (e.g., meat, fish), cereal (e.g., rice, corn), vegetable (e.g., soy, pea, bean), or combinations thereof. The protein can include, or be entirely or partially replaced by, free amino acids known or otherwise suitable for use in nutritional products, non-limiting examples of which include L-alanine, L-arginine, L-asparagine, L-aspartic acid, L-carnitine, L-cystine, L-glutamic acid, L-glutamine, glycine, L-histidine, L-isoleucine, L-leucine, L-lysine, L-methionine, L-phenylalanine, L-proline, L-serine, L-taurine, L-threonine, L-tryptophan, L-tyrosine, L-valine, and combinations thereof.

Carbohydrate

The concentrated liquid human milk fortifiers of the present disclosure comprise a carbohydrate suitable for use in infants, especially preterm infants, at concentrations most typically ranging up to about 75% by weight on a dry weight basis, including from about 5% to about 50%, and also including from about 20% to about 40%, by weight on a dry weight basis.

Carbohydrates suitable for use in the concentrated liquid human milk fortifiers may include maltodextrin (i.e., non-sweet, nutritive polysaccharide having a DE value less than 20), corn maltodextrin, glucose polymers, sucrose, corn syrup, corn syrup solids (i.e., polysaccharide having a DE value greater than 20), glucose, rice syrup, fructose, high fructose corn syrup, indigestible oligosaccharides such as fructooligosaccharides (FOS), and combinations thereof. The carbohydrates may comprise lactose or can be substantially free of lactose. One particularly preferred carbohydrate is maltodextrin.

One embodiment of the present disclosure includes a non-reducing carbohydrate component, which may represent from about 10% to 100%, including from about 80% to 100%, and also including 100%, by weight of the total carbohydrate in the concentrated liquid human milk fortifier. The selection of a non-reducing carbohydrate may enhance the product stability and is generally better tolerated by infants, especially premature infants. Non-limiting examples of non-reducing carbohydrates include sucrose or other carbohydrates that do not readily oxidize or react with Tollen's, Benedict's, or Fehling's reagents. The present disclosure therefore includes those embodiments comprising a carbohydrate component, wherein the carbohydrate component comprises a mono- and/or disaccharide such that at least 50%, including from about 80% to 100%, and also including 100%, of the mono- and/or disaccharide is a non-reducing carbohydrate.

Fat

The concentrated liquid human milk fortifiers of the present disclosure also comprise a fat component suitable for use in infants, especially preterm infants, at concentrations most typically ranging up to about 75% by weight on a dry weight basis, including from about 5% to about 50%, and also including from about 20% to about 40%, by weight on a dry weight basis.

Fats suitable for use in the concentrated liquid human milk fortifiers of the present disclosure may include coconut oil, soy oil, corn oil, olive oil, safflower oil, high oleic safflower oil, MCT oil (medium chain triglycerides), sunflower oil, high oleic sunflower oil, structured triglycerides, palm and palm kernel oils, palm olein, canola oil, marine oils, cottonseed oils, and combinations thereof. Particularly preferred fats include MCT oil, soy oil, and coconut oil, which may be used alone or in any combination.

Suitable fats for use in the concentrated liquid human milk fortifiers include emulsifiers to help the various fortifier components readily disperse when combined with human milk. Non-limiting examples of suitable emulsifiers include glyceryl monostearate, monoglycerides, diglycerides, distilled monoglycerides, soya bean lecithin, polyoxythylene stearate, polyoxyethylene sorbitan mono-oleate, polyoxyethylene sorbitan monopalmitate, polyoxyethylene sorbitan monostearate, ammonium phosphatides, polyoxyethylene sorbitan monolaurate, citric acid esters of mono and diglycerides of fatty acids, tartaric acid esters of mono and diglycerides of fatty acids, and combinations thereof. Natural soy lecithin is especially useful in this respect.

The fat component of the concentrated liquid human milk fortifier may therefore optionally include any emulsifier suitable for use in infant nutritional products. Emulsifier concentrations in these products may range up to about 10%, including from about 1% to about 10%, even more typically from about 1.5% to about 5%, by weight of the total fat component. In one embodiment, the emulsifier is in the product in an amount of about 2%, by weight of the total fat component.

The concentrated liquid human milk fortifiers of the present disclosure also include those embodiments that comprise as part of the fat component one or more of arachidonic acid, docosahexaenoic acid, or combinations thereof, alone or in further combination with linoleic acid, linolenic acid, or both.

Without being limiting, one suitable formulation of macronutrients for the concentrated liquid human milk fortifiers of the present disclosure is set forth in the table below.

| | Grams per 100 Grams | Kcal per nutrients |
|---|---|---|
| | Fortifier | (approximate %) |
| Protein | 9.2 | 28.42 |
| Fat | 4.3 | 29.88 |
| Carbohydrate | 13.5 | 41.7 |
| Ash | 2.74 | — |
| Total Solids | 30 | — |
| Kcal | 129.5 | — |

### Vitamins and Minerals

The concentrated liquid human milk fortifiers of the present disclosure may further comprise any of a variety of vitamins, non-limiting examples of which include vitamin A, vitamin D, vitamin E, vitamin K, thiamine, riboflavin, pyridoxine, vitamin B₁₂, niacin, folic acid, pantothenic acid, biotin, vitamin C, choline, inositol, salts and derivatives thereof, and combinations thereof.

The concentrated liquid human milk fortifiers may also further comprise any of a variety of minerals known or otherwise suitable for use in infant or other nutritional formulas, non-limiting examples of which include phosphorus, magnesium, calcium, zinc, manganese, copper, iodine, sodium, potassium, chloride, selenium, and combinations thereof.

The concentrated liquid human milk fortifiers of the present disclosure include those embodiments comprising per 100 kcal of fortifier solids one or more of the following: vitamin A (from about 250 to about 6500 IU), vitamin D (from about 40 to about 1200 IU), vitamin K, vitamin E (at least 0.3 IU), vitamin C (at least 8 mg), thiamine, vitamin B₁₂, niacin, folic acid, pantothenic acid, biotin, choline (at least 7 mg), and inositol (at least 2 mg).

The concentrated liquid human milk fortifiers also include those embodiments comprising per 100 kcal of the fortifier solids one or more of the following: calcium (at least 50 mg), phosphorus (at least 25 mg), magnesium (at least 6 mg), iodine, zinc (at least 0.5 mg), copper, manganese, sodium (from about 20 to about 60 mg), potassium (from about 80 to about 200 mg), chloride (from about 55 to about 150 mg) and selenium (at least 0.5 mcg).

### Other Optional Ingredients

The concentrated liquid human milk fortifiers of the present disclosure may further optionally comprise other ingredients that may modify the physical, chemical, aesthetic or processing characteristics of the compositions or serve as pharmaceutical or additional nutritional components when used in the targeted population. Many such optional ingredients are known for use in food and nutritional products, including infant formulas, and may also be used in the concentrated liquid human milk fortifiers of the present disclosure, provided that such optional materials are compatible with the materials described herein, are safe and effective for their intended use, and do not otherwise unduly impair product performance.

Non-limiting examples of such optional ingredients include preservatives, anti-oxidants, various pharmaceuticals, buffers, carotenoids, colorants, flavors, nucleotides and nucleosides, thickening agents, prebiotics, sialic acid-containing materials, and other excipients or processing aids.

### Aseptic Packaging

The concentrated liquid human milk fortifiers of the present disclosure may be sterilized and aseptically packaged. The aseptic packaging can be accomplished using any of a variety of techniques well known to those of ordinary skill in the formulation art, so long as the heat treatment is sufficient to achieve long term shelf stability of the concentrated liquid. In one specific example, an aseptic process is utilized that includes a high temperature short time (HTST) processing step (i.e., about 165° F. (74° C.) for about 16 seconds) or an ultra high temperature (UHT) processing step (i.e., about 292° F. (133° C.) for about 5 seconds).

A typical aseptic process in accordance with the present disclosure involves the preparation of a slurry from one or more fluid combinations that may contain water and one or more of the following: carbohydrates, OSA modified waxy potato starch, extensively hydrolyzed casein protein, fats, vitamins and minerals. This slurry is typically emulsified, deaerated, homogenized and cooled to form a sterilized formula, and then aseptically packaged to form a sterilized, aseptically packaged concentrated liquid human milk fortifier. Various other solutions may be added to the slurry at most any time before, during, or after processing.

Suitable aseptic packaging techniques include any of the well known aseptic packaging methods disclosed in the formulation arts for preparing nutritional formulation, all of which are generally directed to the sealing or filling of a sterilized liquid into a sterilized, air-tight container. Many variations on the basic method exist and are well known to those of ordinary skill in the formulation art, non-limiting examples of which are described in U.S. Pat. No. 6,096,358 (Murdick et al.); U.S. Pat. No. 6,227,261 (Das et al.); and U.S. Pat. No. 6,371,319 (Yeaton et al.), which descriptions are incorporated herein by reference.

The aseptically packaged embodiments of the present disclosure may include any container or package suitable for use with liquid human milk fortifiers and also capable of withstanding aseptic processing conditions (e.g., high temperature sterilization). Non-limiting examples of such containers include single or multi use bags, plastic bottles or containers, pouches, metal cans glass bottles, foil or other flexible pouches, syringes, vials, or any other container meeting the above-described criteria.

The aseptically packaged container for these embodiments is typically sterilized prior to being filled with its sterilized contents. The container is most typically sterilized by the application of hydrogen peroxide or other suitable disinfectant to the inside surface of the container. The hydrogen peroxide or other disinfectant is often applied in an atomized mist. After a disinfectant is applied, the container may be transported along a conveyor system during which time the container may be subjected to one or more sprayings of hot sterilized air, preferably hot, sterilized, dry air. The container is then preferably injected with nitrogen gas. The aseptically prepared container is then aseptically filled with sterilized product and sealed.

For aseptic packaging, the concentrated liquid human milk fortifier is typically heat treated with a high temperature short time (HTST) process or an ultra high temperature (UHT) process to sufficiently reduce the bioburden to allow the products to be commercially sterile over an extended shelf life of the finished product exceeding about 12 months. The treated formula is then homogenized at 1000 psi or higher and aseptically packaged.

In an alternative embodiment, the concentrated liquid human milk fortifiers of the present disclosure may also be sterilized and retort packaged utilizing conventional means known in the art.

### Methods of Use

The concentrated liquid human milk fortifier of the present disclosure is used in combination with human milk or other suitable infant formula, wherein the resulting fortified human milk or fortified infant formula has an osmolality suitable for oral administration to an infant. As noted, the osmolality will most typically be less than about 500 mOsm/kg water, more typically from about 300 mOsm/kg water to about 400 mOsm/kg water.

The concentrated liquid human milk fortifier of the present disclosure may be added directly to human milk or to infant formula in a volume to volume ratio of from about 1:3 to about 1:10, including from about 1:3 to about 1:9, including from about 1:3 to about 1:8, including from about 1:3.5 to about 1:7, also including from about 1:4 to about 1:6, and also including from about 1:5 to about 1:6. The ratio is ultimately selected based primarily upon the ingredients and osmolality of the concentrated liquid human milk fortifier and in view of the particular nutritional needs of the infant. The concentrated liquid human milk fortifier may be added directly to every feeding or to a sufficient number of feedings (e.g., once or twice daily) to provide optimal nutrition in view of the particular nutritional needs of the infant.

Human milk or other infant formula, after fortification with the concentrated liquid human milk fortifier will most typically have a caloric density ranging from about 19 kcal/fl oz (0.64 kcal/ml) to about 26.7 kcal/fl oz (0.9 kcal/ml), with the 22-25 kcal/fl oz formulations (0.74-0.84 kcal/ml) being more useful in preterm infants, and the 19-21 kcal/fl oz (0.64-0.71 kcal/ml) formulations more useful for term infants.

The methods of the present disclosure include methods of providing nutrition to infants, and especially preterm infants. As noted herein, preterm infants may especially benefit from the use of human milk fortifiers as the fortifiers can provide additional nutrients to the preterm infant when combined with human breast milk and/or infant formula to foster quicker growth and development. In one particular embodiment, nutrition is provided to an infant by the addition of the concentrated liquid human milk fortifier to human breast milk or infant formula or combination thereof followed by the administration of the fortified human breast milk or infant formula to the infant.

Other alternative methods of the present disclosure include using the human milk fortifiers as described herein to fortify human breast milk, infant formula, or a combination of human breast milk and infant formula to provide a fortified nutritional liquid for administration to an infant, and particularly a preterm infant. In one embodiment, human breast milk is fortified by mixing the concentrated human milk fortifier with human breast milk or infant formula or a combination thereof in a volume to volume ratio of from about 1:3 to about 1:10.

The methods of the present disclosure also include a method of providing nutrition to users other than infants, such as adults and elderly. This method includes the addition of the concentrated composition to other liquid nutritionals such as suspensions, emulsions or clear or substantially clear liquids. The resulting concentrated liquid nutritional compositions may be used as adult liquid nutritional compositions and medicinal liquid nutritional compositions.

### Methods of Manufacture

The concentrated liquid human milk fortifiers of the present disclosure may be prepared in accordance with the methods described hereinafter.

In one embodiment, the concentrated liquid human milk fortifier is prepared by solubilizing and combining/mixing ingredients into a homogeneous aqueous mixture which is subjected to a sufficient thermal treatment and aseptic filling to achieve long term physical and microbial shelf stability.

To begin the manufacturing process, macronutrients (carbohydrate, protein, fat, and minerals) are combined in several slurries together and with water. This blend is subjected to an initial heat treatment and then tested to verify proper nutrient levels. Additional detail on this process is provided in the following paragraphs.

An intermediate aqueous carbohydrate-mineral (CHO-MIN) slurry is prepared by heating an appropriate amount of water. With agitation, the following soluble ingredients are added: maltodextrin, potassium citrate, magnesium chloride, potassium chloride, sodium chloride, and choline chloride. The carbohydrate-mineral slurry is held at elevated temperature under agitation until added to the blend.

An intermediate oil slurry is prepared by heating MCT oil and coconut oil to an elevated temperature and then adding distilled monoglycerides with agitation for a minimum of 10 minutes in order for the ingredient to dissolve. Soy oil, vitamin A palmitate, vitamin D₃, di-alpha-tocopheryl-acetate, phylloquinone, ARA, DHA, and mixed carotenoids are then added with agitation to the oil blend. Insoluble mineral calcium source and ultra micronized tricalcium phosphate are added to the oil. OSA modified waxy potato starch is then added to the oil blend with proper agitation. The oil blend slurry is maintained at an elevated temperature under agitation until added to the blend.

The blend is prepared by combining the ingredient water, casein hydrolysate, all of the CHO-MIN slurry and whole oil blend slurry. The blend is maintained at 120° F. for a period of time not to exceed two hours before further processing.

The blend is then homogenized using one or more in-line homogenizers at pressures from 1000-4000 psig with or without a second stage homogenization from 100-500 psig followed by heat treatment using a UHTST (ultra-high temperature short time, 292-297° F. for 1-30 seconds) process. After the appropriate heat treatment, the batch is cooled in a plate cooler to 33-45° F. and then transferred to a refrigerated holding tank, where it is subjected to analytical testing.

The next step in the manufacturing process involves adding any desired vitamins, trace minerals and water in order to reach the final target total solids and vitamin/mineral contents. The final batch is filled into a suitable container under aseptic conditions or treated with a terminal sterilization process so the product will be stable at room temperature for an extended shelf life. Additional detail on this process is provided in the following paragraphs.

A trace mineral/vitamin/nutrient solution (STD1) is prepared by heating water to 80-100° F. and adding the following ingredients with agitation: potassium citrate, ferrous sulfate, zinc sulfate, copper sulfate, manganese sulfate, sodium selenate, pyridoxine hydrochloride, riboflavin, thiamine hydrochloride, cyanocobalamin, folic acid, calcium pantothenate, niacinamide, biotin, m-inositol, nucleotide/choline premix, L-carnitine, L-leucine, L-tryptophan, and L-tyrosine.

A vitamin C solution (STD2) is prepared by adding ascorbic acid to water solution with agitation.

Both STD1 and STD2 solutions are then added to the refrigerated batch, with agitation. The appropriate amount of ingredient dilution water is then added to the batch to achieve a target total solids level of at least 5%, including at least 10%, and preferably about 20-55%. The final batch is then subjected to appropriate thermal treatment and filled into a suitable container under aseptic conditions and processes.

The concentrated liquid human milk fortifiers of the present disclosure may, of course, be manufactured by other known or otherwise suitable techniques not specifically described or shown herein without departing from the spirit and scope of the present disclosure. The present embodiments are, therefore, to be considered in all respects as illustrative and not restrictive and that all changes and equivalents also come within the description of the present disclosure. The following non-limiting examples will further illustrate the formulations and methods of the present disclosure.

### EXAMPLES

The following examples illustrate specific embodiments and/or features of the concentrated liquid human milk fortifiers of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the formulation, unless otherwise specified.

### Examples 1-4

In Examples 1-4, concentrated liquid human milk fortifiers may be prepared in accordance with the present disclosure. The ingredients for the concentrated liquid human milk fortifier are shown in the following table. All ingredient amounts are listed as pound per approximately 1000 pound batch of product, unless otherwise specified.

| Ingredient | | | | | | | | |
|---|---|---|---|---|---|---|---|---|
| (Per 1000 Lb) | Example 1 | | Example 2 | | Example 3 | | Example 4 | |
| Ingredient Water | q.s. | | q.s. | | q.s. | | q.s. | |
| Casein Hydrolysate | 110.5 | | 110.5 | | 110.5 | | 110.5 | |
| Maltodextrin | 110.5 | | 110.5 | | 110.5 | | 110.5 | |
| MCT Oil | 18.9 | | 18.9 | | 18.9 | | 18.9 | |
| Tricalcium Phosphate | 14.8 | | 14.8 | | 14.8 | | 14.8 | |
| OSA Modified Waxy | 12.0 | | 10.8 | | 9.6 | | 13.2 | |
| Potato Starch | | | | | | | | |
| Soy Oil | 11.3 | | 11.3 | | 11.3 | | 11.3 | |
| Coconut Oil | 6.9 | | 6.9 | | 6.9 | | 6.9 | |
| Potassium Citrate | 5.2 | | 5.2 | | 5.2 | | 5.2 | |
| Magnesium Chloride | 3.4 | | 3.4 | | 3.4 | | 3.4 | |
| Ascorbic Acid | 3.3 | | 3.3 | | 3.3 | | 3.3 | |
| M. Alpina Oil | 2.6 | | 2.6 | | 2.6 | | 2.6 | |
| C. Cohnii Oil | 2.1 | | 2.1 | | 2.1 | | 2.1 | |
| Leucine | 1.8 | | 1.8 | | 1.8 | | 1.8 | |
| Potassium Chloride | 1.7 | | 1.7 | | 1.7 | | 1.7 | |
| Tyrosine | 1.4 | | 1.4 | | 1.4 | | 1.4 | |
| Monoglycerides | 390.1 | g | 390.1 | g | 390.1 | g | 390.1 | g |
| Sodium Chloride | 345.3 | g | 345.3 | g | 345.3 | g | 345.3 | g |
| M-Inositol | 200.0 | g | 200.0 | g | 200.0 | g | 200.0 | g |
| Choline Chloride | 160.0 | g | 160.0 | g | 160.0 | g | 160.0 | g |
| Tryptophan | 150.0 | g | 150.0 | g | 150.0 | g | 150.0 | g |
| Zinc Sulfate | 130.3 | g | 130.3 | g | 130.3 | g | 130.3 | g |
| Niacinamide | 127.3 | g | 127.3 | g | 127.3 | g | 127.3 | g |
| di-Alpha-Tocopheryl | 108.7 | g | 108.7 | g | 108.7 | g | 108.7 | g |
| Acetate | | | | | | | | |
| L-Carnitine | 100.0 | g | 100.0 | g | 100.0 | g | 100.0 | g |
| Calcium Pantothenate | 60.0 | g | 60.0 | g | 60.0 | g | 60.0 | g |
| Ferrous Sulfate | 52.0 | g | 52.0 | g | 52.0 | g | 52.0 | g |
| Vitamin A Palmitate | 25.8 | g | 25.8 | g | 25.8 | g | 25.8 | g |
| Riboflavin | 15.0 | g | 15.0 | g | 15.0 | g | 15.0 | g |
| Thiamin Hydrochloride | 11.0 | g | 11.0 | g | 11.0 | g | 11.0 | g |
| Pyridoxine | 8.9 | g | 8.9 | g | 8.9 | g | 8.9 | g |
| Hydrochloride | | | | | | | | |
| Cupric Sulfate | 6.0 | g | 6.0 | g | 6.0 | g | 6.0 | g |
| Vitamin D3 | 6.4 | g | 6.4 | g | 6.4 | g | 6.4 | g |
| lutein | 3.2 | g | 3.2 | g | 3.2 | g | 3.2 | g |
| Folic Acid | 1.4 | g | 1.4 | g | 1.4 | g | 1.4 | g |
| Beta Carotene | 940.0 | mg | 940.0 | mg | 940.0 | mg | 940.0 | mg |
| Biotin | 860.0 | mg | 860.0 | mg | 860.0 | mg | 860.0 | mg |
| Manganese Sulfate | 840.0 | mg | 840.0 | mg | 840.0 | mg | 840.0 | mg |
| Phylloquinone | 285.0 | mg | 285.0 | mg | 285.0 | mg | 285.0 | mg |
| Sodium Selenate | 44.0 | mg | 44.0 | mg | 44.0 | mg | 44.0 | mg |
| Cyanocobalamin | 40.0 | mg | 40.0 | mg | 40.0 | mg | 40.0 | mg |

| | | | | |
|---|---|---|---|---|
| Potassium Hydroxide | q.s. | q.s. | q.s. | q.s. |

The concentrated liquid human milk fortifier is prepared by solubilizing and combining/mixing ingredients into a homogeneous aqueous mixture which is subjected to a sufficient thermal treatment and aseptic filling to achieve long term physical and microbial shelf stability.

To begin the manufacturing process, macronutrients (carbohydrate, protein, fat, and minerals) are combined in several slurries together and with water. This blend is subjected to an initial heat treatment and then tested to verify proper nutrient levels. Additional detail on this process is provided in the following paragraphs.

An intermediate aqueous carbohydrate-mineral (CHO-MIN) slurry is prepared by heating an appropriate amount of water to 140-160° F. With agitation, the following soluble ingredients are added: maltodextrin, potassium citrate, magnesium chloride, potassium chloride, sodium chloride, and choline chloride. The carbohydrate-mineral slurry is held at 130-150° F. under agitation until added to the blend.

An intermediate oil slurry is prepared by heating MCT oil and coconut oil to 150 to 170° F. and then adding distilled monoglycerides with agitation for a minimum of 10 minutes in order for the ingredient to dissolve. Soy oil, vitamin A palmitate, di-alpha-tocopheryl acetate, phylloquinone, vitamin D3, ARA-containing oil, DHA-containing oil, lutein, and beta-carotene are then added with agitation to the oil blend. Insoluble mineral calcium source, and ultra micronized tricalcium phosphate is added to the oil. OSA modified waxy potato starch is then added to the oil blend with proper agitation. The oil blend slurry is maintained at 130-150° F. under agitation until added to the blend.

The blend is prepared by combining the ingredient water, casein hydrolysate, all of the CHO-MIN slurry and whole oil blend slurry. The blend is maintained at 120° F. for a period of time not to exceed two hours before further processing.

The blend is then homogenized using one or more in-line homogenizers at pressures from 1000-4000 psig with or without a second stage homogenization from 100-500 psig followed by heat treatment using a HTST (high temperature short time, 165-185° F. for 15-20 seconds) process. After the appropriate heat treatment, the batch is cooled in a plate cooler to 33-45° F. and then transferred to a refrigerated holding tank, where it is subjected to analytical testing.

The next step in the manufacturing process involves adding vitamins, trace minerals, other ingredients, and water in order to reach the final target total solids and vitamin/mineral contents. The final pH of the product prior to thermal treatment is also adjusted. The final batch is filled into a suitable container under aseptic conditions or treated with a terminal sterilization process so the product will be stable at room temperature for an extended shelf-life. Additional detail on this process is provided in the following paragraphs.

A trace mineral/vitamin/nutrient solution (STD1) is prepared by heating water to 80-100° F. and adding the following ingredients with agitation: potassium citrate, ferrous sulfate, zinc sulfate, copper sulfate, manganese sulfate, sodium selenate, pyridoxine hydrochloride, riboflavin, thiamine hydrochloride, vitamin B₁₂, folic acid, calcium pantothenate, niacinamide, biotin, m-inositol, L-carnitine, leucine, and tyrosine.

A vitamin C solution (STD2) is prepared by adding ascorbic acid to a water solution with agitation.

All STD1 and STD2 solutions are then added to the refrigerated batch, with agitation. The appropriate amount of ingredient dilution water is then added to the batch to achieve a target total solids level of 20.0-55.0%. The final pH of the product prior to thermal treatment is adjusted to >4.6-5.0 by addition of citric acid. The final batch is then subjected to appropriate thermal treatment and filled into a suitable container under an aseptic conditions and processes.

### Example 5

In this Example, the stabilization characteristics of OSA modified waxy potato starch in a concentrated liquid human milk fortifier were analyzed and compared to a control concentrated liquid human milk fortifier without a stabilizer and a concentrated liquid human milk fortifier using OSA modified waxy corn starch as a stabilizer.

Three samples of liquid human milk fortifier including extensively hydrolyzed casein were prepared using a method similar to the method described in Examples 1-4. A first sample was the control to which no stabilizer was added. A second sample was prepared including 1.2% by weight OSA modified waxy corn starch (Uni-Pure® IMF 2332, Ingredion Incorporated (Westchester, Ill.) Starch Food Innovation, Bridgewater, N.J.) as a stabilizer. A third sample was prepared including 1.2% by weight OSA modified waxy potato starch (ELAINE™ MC-160, AVEBE, The Netherlands) as a stabilizer. The samples were then stored at least 6 months at room temperature.

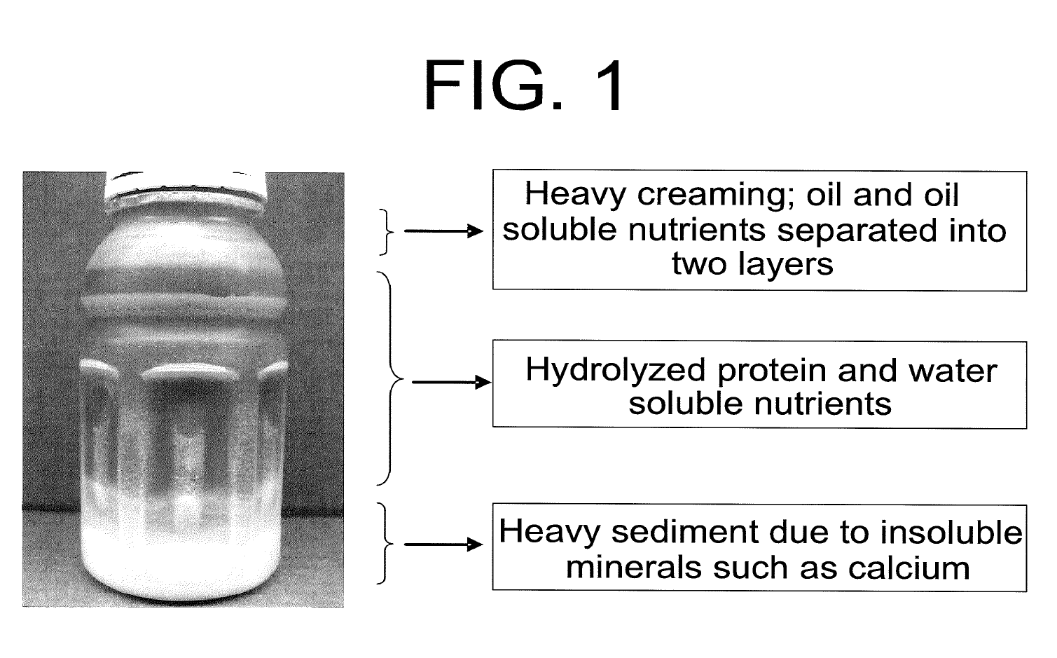

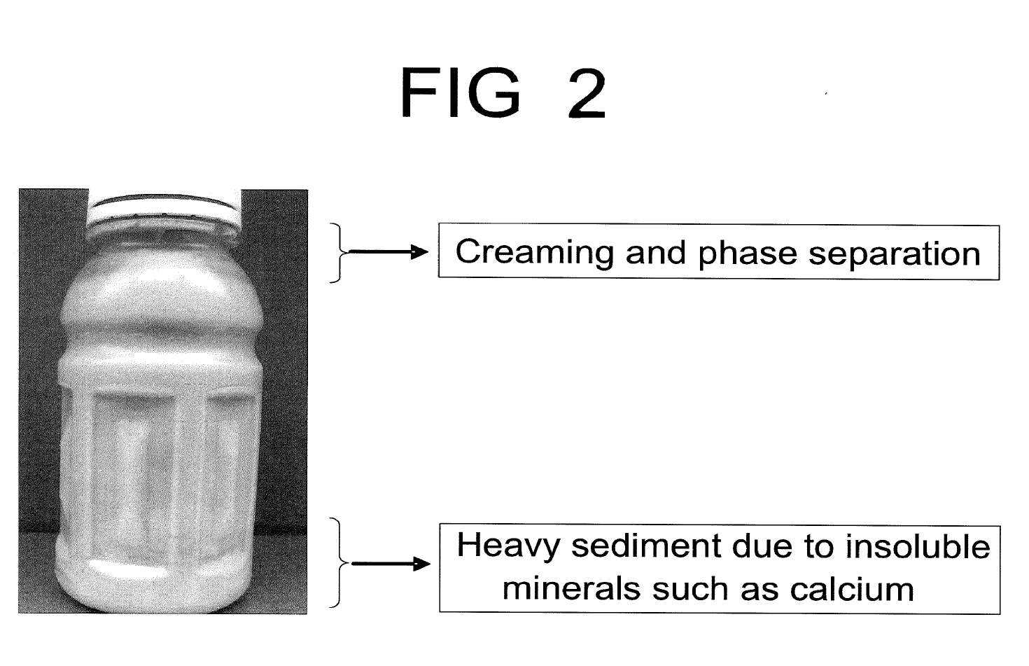

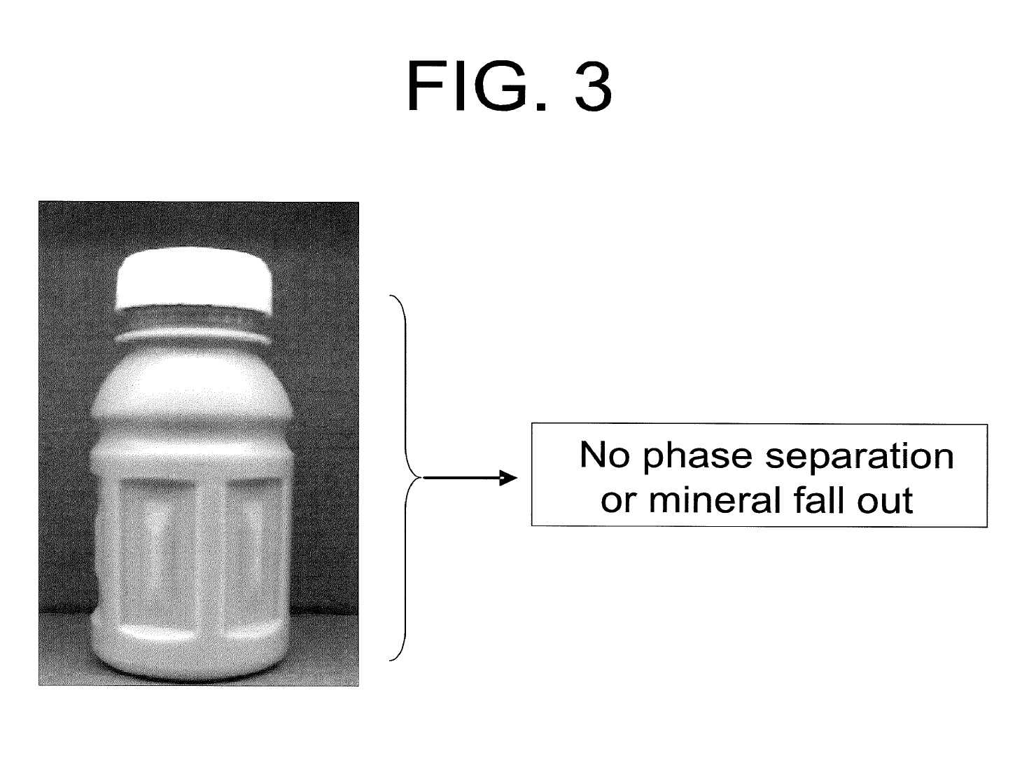

As shown in the figures, the control sample (FIG. 1) showed heavy creaming, wherein oil and oil soluble nutrients separated into two different layers. Further, there was heavy sedimentation of insoluble minerals such as calcium. The second sample (FIG. 2), which included the OSA modified waxy corn starch, showed some creaming and phase separation. Further, the second sample had heavy sedimentation due to insoluble minerals. The third sample (FIG. 3), which included OSA modified waxy potato starch, showed no phase separation or mineral sedimentation (i.e., mineral fallout). This indicates that the use of OSA modified waxy potato starch as a stabilizer allowed for a stable concentrated liquid human milk fortifier to be prepared to contain extensively hydrolyzed casein and high levels of insoluble minerals without causing mineral fallout or defects in emulsion stability.

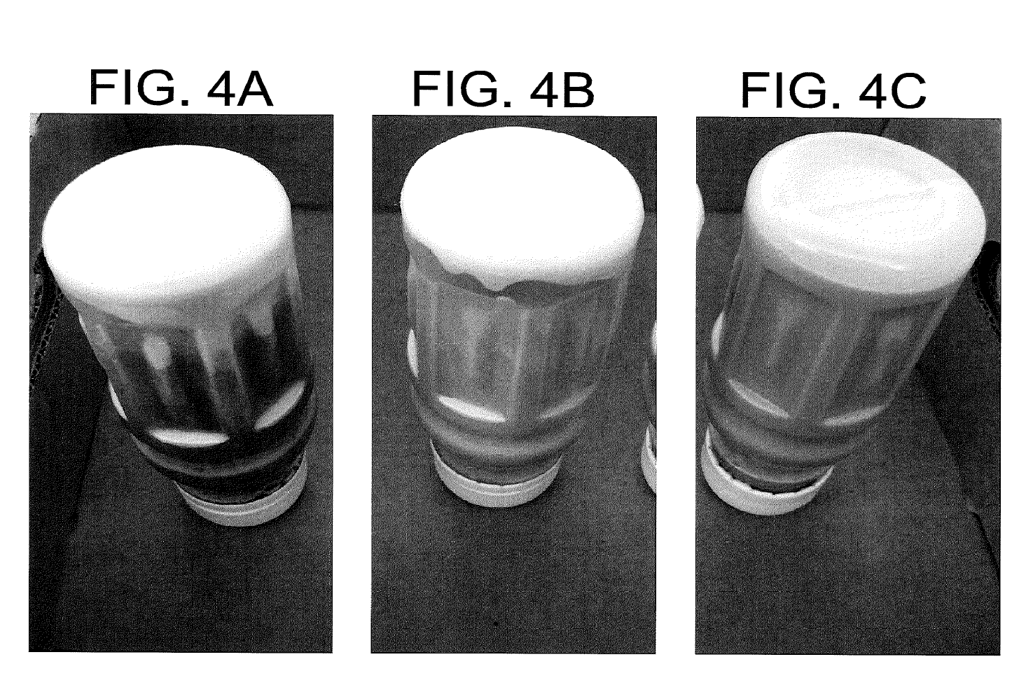

Further, the bottles including the three samples were turned upside down and the results are shown in FIGS. 4A-4C. As shown in FIG. 4A, the control sample shows heavy creaming and sedimentation. The second sample (FIG. 4B) including OSA modified waxy corn starch shows some creaming and sedimentation. The third sample (FIG. 4C) including OSA modified waxy potato starch shows little to no creaming along with little to no sedimentation.

### Example 6

In this Example, concentrated liquid human milk fortifiers having varying stabilizers were analyzed for elasticity behavior as a function of deformation (i.e., strain).

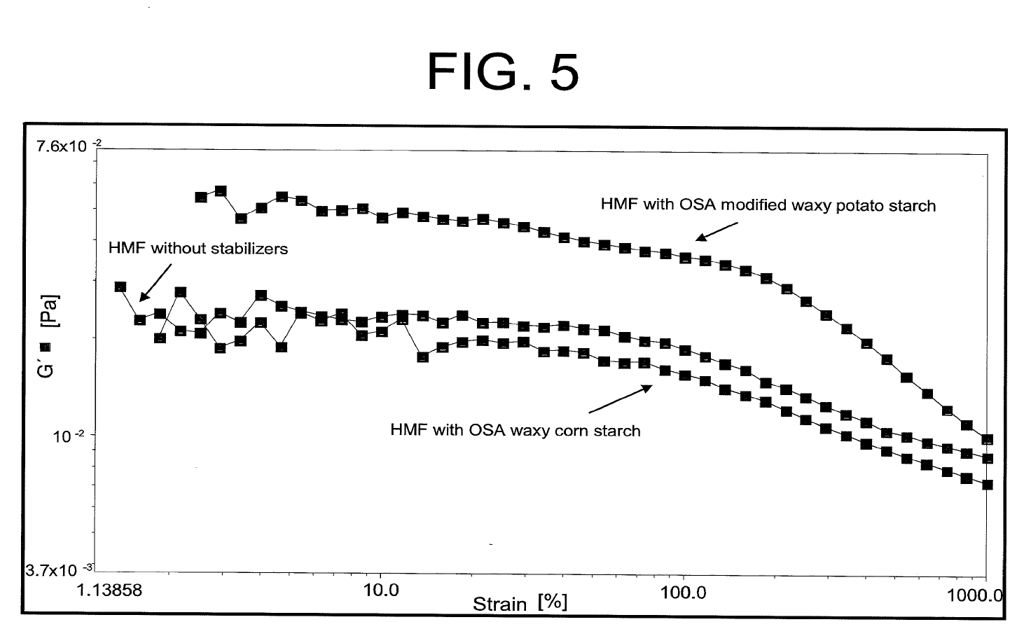

Three concentrated liquid human milk fortifiers as prepared in Example 5 were used for this Example. Strain sweep measurements for each sample were then obtained using an ARES G2 rheometer, available from TA Instruments (New Castle, Del.). The linear range in the resulting data corresponded to elastic modulus wherein change as a function of strain was insignificant. The line fit was performed to identify the plateau elastic modulus. The frequency of the measurement was 10 rad/s. The results are shown in FIG. 5.

As shown in FIG. 5, the sample including OSA modified waxy potato starch demonstrates a long linear range with no instabilities indicating stable emulsion and suspension characteristics. The sample including OSA modified waxy corn starch demonstrates break in the structure, indicating instabilities at low strains and having low elastic modula associated with a small linear range. This indicates that this sample does not have as stable of emulsion and suspension characteristics as compared to the sample including OSA modified waxy potato starch. The control sample shows instabilities at low strains with break in the structure and minimal linear range, which is a sign of poor emulsion and suspension characteristics.

### Example 7

In this Example, concentrated liquid human milk fortifiers having varying stabilizers were analyzed for dynamic modula as a function of frequency and temperature.

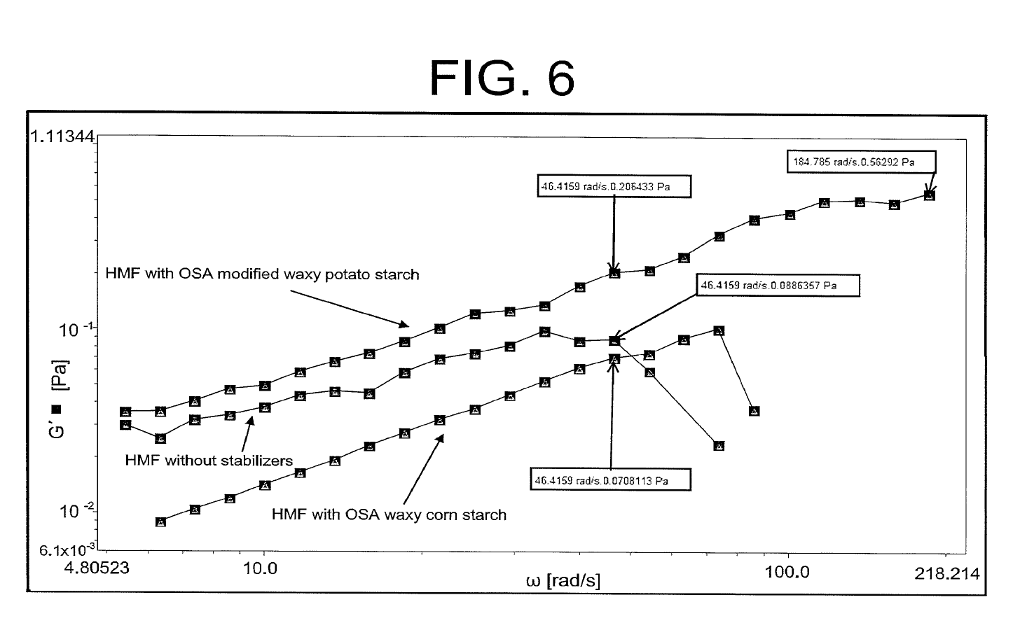

The three concentrated liquid human milk fortifiers as prepared in Example 5 were used for this Example. Strain sweep measurements for each sample were obtained as in Example 6 as a function of strain at room temperature. The frequency of the measurements ranged from about 4.8 rad/s to about 218.2 rad/s. The results are shown in FIG. 6.

As shown in FIG. 6, the dynamic modula, e.g., 88.6 mPa at 46.4 rad/s, for the control sample at low frequencies was low, indicating poor suspension stability. It is expected that this sample would be a viscoelastic gel. Gel-like products typically squeeze water out, causing phase separation. This sample's strain sweep spectra also showed instabilities at low strains with very small linear range, further confirming lack of emulsion and suspension stabilities.

The dynamic modula, e.g., 70.8 mPa at 46.4 rad/s, for the sample with OSA modified waxy corn starch at low frequencies was also low, indicating poor suspension stability.

The OSA modified waxy potato starch sample's mechanical spectra demonstrates that the product is a viscoelastic liquid having no gel-like behavior. Further, the low frequency elastic modula, e.g., 206.4 mPa at 46.4 rad/s, is significantly larger than the other samples with no defects showing improved suspension stability. In addition, the high frequency elastic modula, e.g., 562.9 mPa at 184.8 rad/s, is significantly larger than the other samples with no defects indicating good emulsion characteristics. Both measurements of elastic modula as a function of frequency and strain sweep were aligned well, showing good emulsion and suspension characteristics for this sample.

1. A concentrated liquid human milk fortifier comprising from 1% to 50% by weight protein on a dry weight basis and octenyl succinic anhydride modified waxy potato starch, wherein at least a portion of the protein is extensively hydrolyzed casein.

2. The concentrated liquid human milk fortifier according to claim 1, wherein 100% by weight of the protein is extensively hydrolyzed casein.

3. The concentrated liquid human milk fortifier according to claim 1, wherein the fortifier comprises from 0.1% to 3.5% by weight of octenyl succinic anhydride modified waxy potato starch based on the weight of the fortifier.

4. The concentrated liquid human milk fortifier according to claim 1, wherein the octenyl succinic anhydride modified waxy potato starch is a sole stabilizer of the fortifier.

5. The concentrated liquid human milk fortifier according to claim 1, wherein the fortifier comprises a solids content of at least 5% by weight.

6. The concentrated liquid human milk fortifier according to claim 1, wherein the fortifier is an aseptically-sterilized concentrated liquid human milk fortifier.

7. (canceled)

8. The concentrated liquid human milk fortifier according to claim 1, wherein the fortifier is carrageenan-free and comprises from 1% to 50% by weight of extensively hydrolyzed hypoallergenic casein on a dry weight basis, from 0.8% to 1.5% by weight of octenyl succinic anhydride modified waxy potato starch based on the weight of the fortifier, and a solids content of from 20% to 55% by weight.

9. The concentrated liquid human milk fortifier according to claim 8, wherein the octenyl succinic anhydride modified waxy potato starch is a sole stabilizer of the fortifier.

10. (canceled)

11. A method of fortifying breast milk comprising mixing a concentrated liquid human milk fortifier with breast milk in a respective volume to volume ratio of from 1:3 to 1:10, the fortifier comprising from 1% to 50% by weight protein on a dry weight basis and octenyl succinic anhydride modified waxy potato starch, wherein at least a portion of the protein is extensively hydrolyzed casein.

12. The method according to claim 11, wherein 100% by weight of the protein is extensively hydrolyzed casein.

13. The method according to claim 11, wherein the extensively hydrolyzed casein is hypoallergenic protein.

14. The method according to claim 11, wherein the fortifier comprises from 0.1% to 3.5% by weight of octenyl succinic anhydride modified waxy potato starch based on the weight of the fortifier.

15. The method according to claim 11, wherein the octenyl succinic anhydride modified waxy potato starch is a sole stabilizer of the fortifier.

16. The concentrated liquid human milk fortifier according to claim 1 further comprising at least one of fat, vitamins, and minerals.

17. The concentrated liquid human milk fortifier according to claim 1, wherein the concentrated liquid human milk fortifier is free of carrageenan.

18. The concentrated liquid human milk fortifier according to claim 1, wherein the extensively hydrolyzed casein is hypoallergenic protein.

19. The concentrated liquid human milk fortifier according to claim 1, wherein the fortifier comprises from 0.8% to 1.5% by weight of octenyl succinic anhydride modified waxy potato starch based on the weight of the fortifier.

20. The concentrated liquid human milk fortifier according to claim 1, wherein the fortifier comprises a solids content from 20% to 55% by weight.

21. The method according to claim 11, wherein the volume to volume ratio of the fortifier to breast milk ranges from 1:3.5 to 1:7.

22. The method according to claim 11, wherein the fortifier comprises from 0.8% to 1.5% by weight of octenyl succinic anhydride modified waxy potato starch based on the weight of the fortifier.
